(19) United States
(12) Patent Application Publication
(10) Pub. No.: US 2005/0225797 A1
(43) Pub. Date: Oct. 13, 2005

(54) Printing apparatus and its control method, and program

(75) Inventor: Takuto Harada, Yokohama-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/102,660

(22) Filed: Apr. 11, 2005

(30) Foreign Application Priority Data
Apr. 12, 2004 (JP) 2004-117057

(51) Int. Cl. G06F 15/00

(52) U.S. Cl. 358/1.15

(57) ABSTRACT

Print data is received. Processing required to execute a printing process based on that print data is applied to the print data. Processed data generated in the process of the processing is stored in one of storage devices incorporated in devices including the printing apparatus of interest on the network. Identification information indicating the storage location of the processed data is appended to image data corresponding to the print data. The image data appended with the identification information is printed.

### FIELD OF THE INVENTION

The present invention relates to a printing apparatus which is connected to a plurality of devices via a network, and executes a printing process based on print data received from the plurality of devices, its control method, and a program.

### BACKGROUND OF THE INVENTION

Conventionally, copying (copying operation) optically scans a document (print) to be copied, and prints using the scanned image, thus generating a copy of the document.

Also, the following system is known (e.g., Japanese Patent Laid-Open No. 8-50598). When a printing process is made based on application data generated by a dedicated application, that application data is held in a dedicated terminal such as a personal computer (PC) or the like on which the dedicated application runs. After that, when the print is to be copied, in place of recognizing the location of application data corresponding to the print and optically scanning the print, a printing process is done using the held application data, thus generating a copy of that print.

However, in the conventional copying operation, since a document is optically scanned, and a printing process is done using that scanned document image, the image quality of that copy is lower than the scanned document due to scan noise and the like upon scanning.

In the system that generates a copy of a scanned document using application data, the dedicated terminal and dedicated application are required, thus limiting an operation environment. In the copying operation, the application data is rendered to image data using the dedicated application, and a copy of that image data is generated. Hence, a long processing time is required.

### SUMMARY OF THE INVENTION

The present invention has been made to solve the aforementioned problems, and has as its object to provide a printing apparatus which can efficiently implement a copying process without any image quality drop, its control method, and a program.

According to the present invention, the foregoing object is attained by providing a printing apparatus which is connected to a plurality of devices via a network, and executes a printing process on the basis of print data received from the plurality of devices, comprising:

a receiving unit adapted to receive the print data;

a processing unit adapted to apply to the print data processing required to execute the printing process based on the print data;

a storing unit adapted to store processed data generated during a process of the processing of the processing unit in one of storage devices incorporated in the devices including the printing apparatus on the network;

an appending unit adapted to append identification information indicating a storage location of the processed data by the storing unit to image data corresponding to the print data; and

a printing unit adapted to print the image data to which the identification information is appended by the appending unit.

In a preferred embodiment, the print data is print data in a PDL format, and

the processed data is intermediate language data obtained by interpreting the print data in the PDL format or image data corresponding to the print data in the PDL format.

In a preferred embodiment, when a storage device included in the printing apparatus has no free storage area, the storing unit stores the processed data in one of the storage devices incorporated in the devices other than the printing apparatus on the network.

In a preferred embodiment, the apparatus further comprises:

a storage device adapted to store data;

a registration unit adapted to register, when the processed data including a registration request is received from the device on the network, the processed data in the storage device; and

a registration control unit adapted to reduce, when the free storage area required to store the processed data to be registered is used up during registration of the processed data to be registered by the registration unit, data that have already been stored in the storage device, and register the processed data to be registered in the storage device.

In a preferred embodiment, the registration control unit registers the processed data to be registered in the storage device while erasing data stored in the storage device in an order of older ones.

In a preferred embodiment, the registration control unit registers the processed data to be registered in the storage device while erasing data stored in the storage device in an order of older accesses.

In a preferred embodiment, the registration control unit registers the processed data to be registered in the storage device while erasing data stored in the storage device in an order of data for which a predetermined period of time have elapsed.

In a preferred embodiment, the registration control unit registers the processed data to be registered in the storage device while applying compression at a higher compression rate to data stored in the storage device and re-saving the compressed data in an order of data with older registration dates.

In a preferred embodiment, the registration control unit registers the processed data to be registered in the storage device while searching the data stored as intermediate language data in the storage device for data which may have a smaller size if it is saved as image data, rendering the found data, and re-saving the rendered data as image data.

In a preferred embodiment, the apparatus further comprises:

a scanning unit adapted to optically scan a document; and

an acquisition unit adapted to acquire, when the document scanned by the scanning unit includes the identification information, the processed data corresponding to the identification information from the storage location specified by the identification information, and wherein the printing unit executes the printing process based on the processed data acquired by the acquisition unit.

In a preferred embodiment, the foregoing object is attained by providing a method of controlling a printing apparatus which is connected to a plurality of devices via a network, and executes a printing process on the basis of print data received from the plurality of devices, comprising:

a receiving step of receiving the print data;

a processing step of applying processing required to execute the printing process based on the print data to the print data;

a storing step of storing processed data generated during a process of the processing in the processing step in one of storage devices incorporated in the devices including the printing apparatus on the network;

an appending step of appending identification information indicating a storage location of the processed data in the storing step to image data corresponding to the print data; and

a printing step of printing the image data to which the identification information is appended in the appending step.

In a preferred embodiment, the foregoing object is attained by providing program for implementing control of a printing apparatus which is connected to a plurality of devices via a network, and executes a printing process on the basis of print data received from the plurality of devices, comprising:

a program code of a receiving step of receiving the print data;

a program code of a processing step of applying processing required to execute the printing process based on the print data to the print data;

a program code of a storing step of storing processed data generated during a process of the processing in the processing step in one of storage devices incorporated in the devices including the printing apparatus on the network;

a program code of an appending step of appending identification information indicating a storage location of the processed data in the storing step to image data corresponding to the print data; and

a program code of a printing step of printing the image data to which the identification information is appended in the appending step.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the arrangement of a print management system according to an embodiment of the present invention;

FIG. 2 is a block diagram showing the arrangement including software modules of respective devices which form the print management system according to the embodiment of the present invention;

FIG. 3 is a flowchart showing a printing process according to the embodiment of the present invention;

FIG. 4 is a flowchart showing a storage device search/registration process according to the embodiment of the present invention;

FIG. 5 is a flowchart showing a copying process according to the embodiment of the present invention;

FIG. 6 is a flowchart showing a get request response process according to the embodiment of the present invention;

FIG. 7 shows an example of the data configuration of a storage device search request command according to the embodiment of the present invention;

FIG. 8 shows an example of the data configuration of a storage device search result command according to the embodiment of the present invention;

FIG. 9 shows an example of the data configuration of a registration request command according to the embodiment of the present invention;

FIG. 10 shows an example of the data configuration of a get request command according to the embodiment of the present invention; and

FIG. 11 shows an example of the data configuration of a get result command according to the embodiment of the present invention.

### DETAILED DESCRIPTION OF THE PREFERRED EMBODIMENTS

Preferred embodiments of the present invention will now be described in detail in accordance with the accompanying drawings.

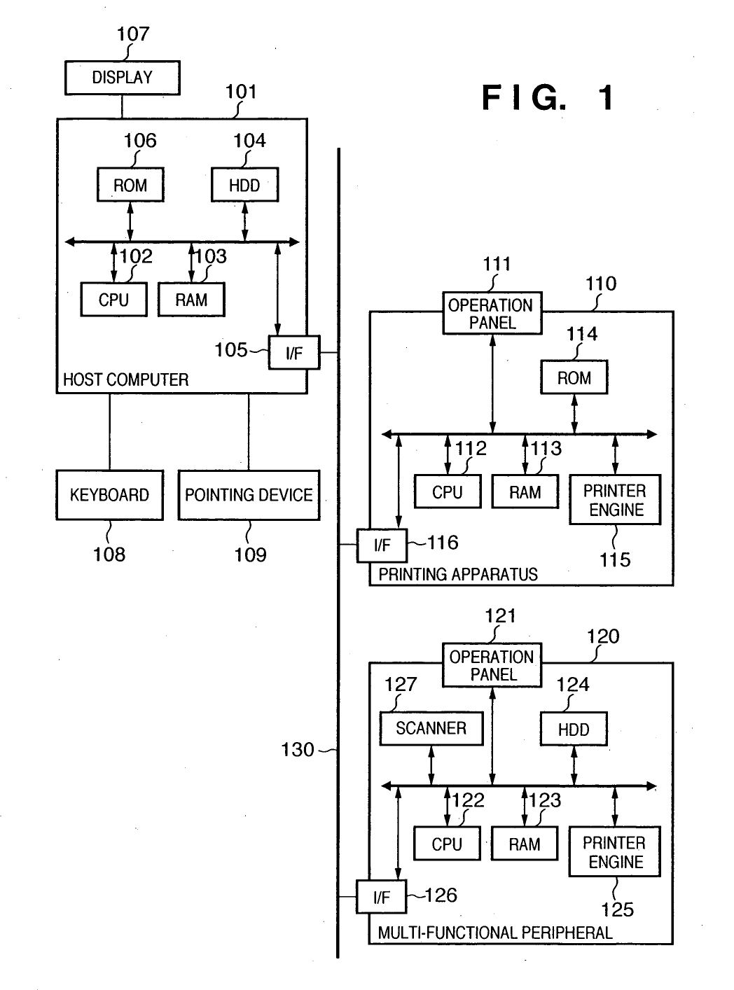

FIG. 1 is a block diagram showing the arrangement of a print management system according to an embodiment of the present invention.

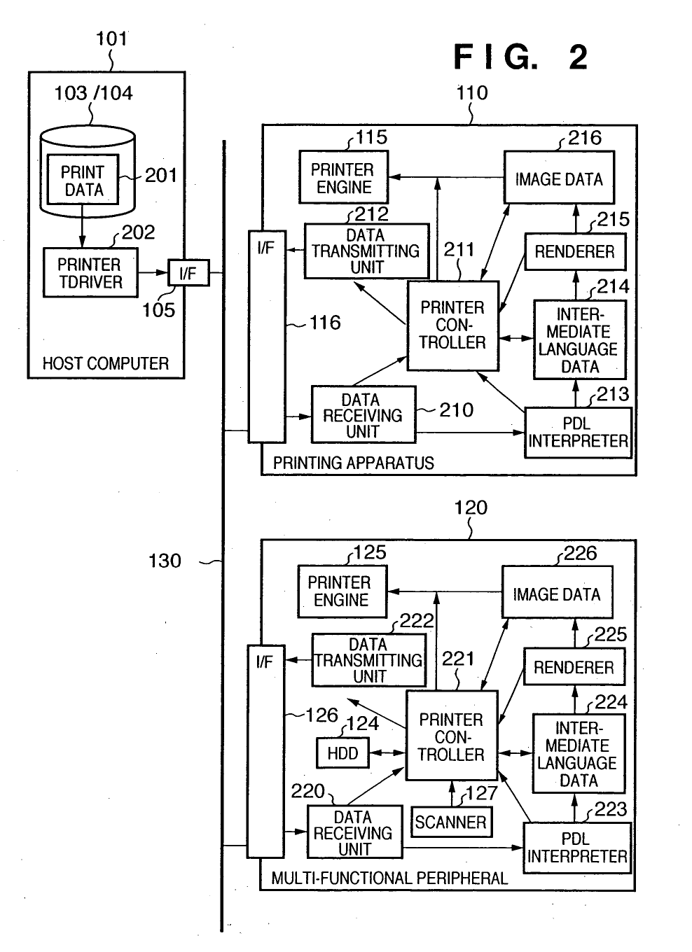

Reference numeral 101 denotes a host computer. Reference numeral 102 denotes a CPU. All software programs (to be described later using FIG. 2 and the like) run on the host computer 101 under the control of the CPU 102.

Reference numeral 103 denotes a RAM. Software which runs under the control of the CPU 102 uses the RAM 103 to save data and for the operation by itself. Reference numeral 104 denotes an HDD (hard disk drive) which stores various programs of the software and data. Reference numeral 105 denotes a communication interface (I/F). Reference numeral 106 denotes a ROM which stores various programs of the software and data.

Reference numeral 107 denotes a display which displays various kinds of information. The display 107 comprises, e.g., an LCD or CRT. Reference numeral 108 denotes a keyboard which is used to make various inputs. Reference numeral 109 denotes a pointing device which is used to make various inputs. The pointing device 109 comprises, e.g., a mouse or pen.

Reference numeral 110 denotes a printing apparatus. The printing apparatus 110 can use various printing systems such as a laser beam system, ink-jet system, thermal transfer system, and the like. Reference numeral 111 denotes an operation panel, which is used to make various operation settings of the printing apparatus 110. The operation panel 111 comprises, e.g., a touch panel, various keys and buttons. Reference numeral 112 denotes a CPU. All software programs (to be described later using FIG. 2 and the like) run on the printing apparatus 110 under the control of the CPU 112.

Reference numeral 113 denotes a RAM. Software which runs under the control of the CPU 112 uses the RAM 113 to save data and for the operation by itself. Reference numeral 114 denotes a ROM which stores various programs of the software and data. Reference numeral 115 denotes a printer engine which prints an image generated by software which runs under the control of the CPU 112. Reference numeral 116 denotes a communication interface (I/F).

Reference numeral 120 denotes a multi-functional peripheral (MFP) which has at least an image scanning function and image printing function. Reference numeral 121 denotes an operation panel which is used to make various operation settings of the MFP 120. The operation panel 121 comprises, e.g., a touch panel, various keys and buttons. Reference numeral 122 denotes a CPU. All software programs (to be described later using FIG. 2 and the like) run on the MFP 120 under the control of the CPU 122.

Reference numeral 123 denotes a RAM. Software which runs under the control of the CPU 122 uses the RAM 123 to save data and for the operation by itself. Reference numeral 124 denotes an HDD which stores various programs of the software and data. Reference numeral 125 denotes a printer engine which prints an image generated by software which runs under the control of the CPU 122. Reference numeral 126 denotes a communication interface (I/F). Reference numeral 127 denotes a scanner which scans a print (document) to acquire a digital image.

Various devices including the host computer 101, printing apparatus 110, and MFP 120 are connected to each other via a network 130 and can exchange data.

The network 130 is a so-called communication network typically implemented by one of the Internet, a LAN, WAN, and telephone line, a dedicated digital line, an ATM and frame relay line, a communication satellite line, a cable television line, a data broadcasting wireless channel, and the like, or a combination of them. The network 130 need only exchange data.

The arrangement of software modules of the respective devices which form the print management system shown in FIG. 1 will be explained using FIG. 2.

FIG. 2 is a block diagram showing the arrangement including software modules of the respective devices which form the print management system according to the embodiment of the present invention.

In the host computer 101, reference numeral 201 denotes print data held in the RAM 103 or HDD 104. Reference numeral 202 denotes a general printer driver used to print the print data 201. The printer driver 202 is not a special function for the present invention.

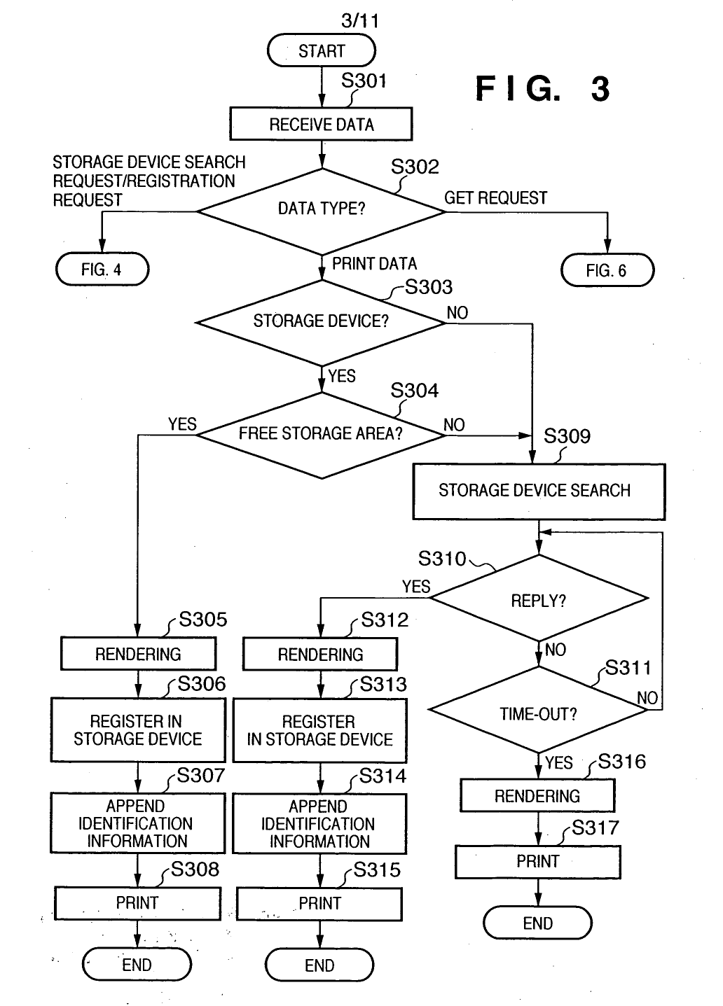

In the printing apparatus 110, reference numeral 210 denotes a data receiving unit which interprets data received by the communication interface 116, and determines a transfer destination (output destination) of the received data on the basis of the interpretation result. Reference numeral 211 denotes a printer controller which plays a key role in the present invention. Note that the detailed functions of the printer controller 211 will be explained in the flowcharts of FIG. 3 and subsequent figures.

Reference numeral 212 denotes a data transmitting unit which transmits inquiry data from the printer controller 211 to another printing apparatus on the network 130. Reference numeral 213 denotes a PDL interpreter which interprets received print data in the PDL (Page Description Language) format. As the PDL interpreter 213, for example, various interpreters such as PostScript(R), LIPS(R), and the like are available.

Reference numeral 214 denotes intermediate language data which can be interpreted by the printing apparatus 110 after the PDL part of the print data has been interpreted by the PDL interpreter 213. Reference numeral 215 denotes a renderer which generates image data 216 on the basis of the intermediate language data 214 as input data.

In the MFP 120, reference numeral 220 denotes a data receiving unit which interprets data received by the communication interface 126, and determines a transfer destination (output destination) of the received data on the basis of the interpretation result. Reference numeral 221 denotes a printer controller which plays a key role in the present invention. Note that the detailed functions of the printer controller 221 will be explained in the flowcharts of FIG. 3 and subsequent figures.

Reference numeral 222 denotes a data transmitting unit which transmits inquiry data from the printer controller 221 to another printing apparatus on the network 130. Reference numeral 223 denotes a PDL interpreter which interprets received print data.

Reference numeral 224 denotes intermediate language data which can be interpreted by the printing apparatus 110 after the PDL part of the print data has been interpreted by the PDL interpreter 223. Reference numeral 225 denotes a renderer which generates image data 226 on the basis of the intermediate language data 224 as input data.

The printing process executed when the device (printing apparatus 110 or MFP 120) on the network 130 receives print data as received data will be described below using FIG. 3.

FIG. 3 is a flowchart showing a printing process according to the embodiment of the present invention.

The user designates the print data 201 using the printer driver 202 by designating one of the printing apparatus 110 and MFP 120 so as to print the print data 201.

Assume that the user designates the MFP 120 in the following description.

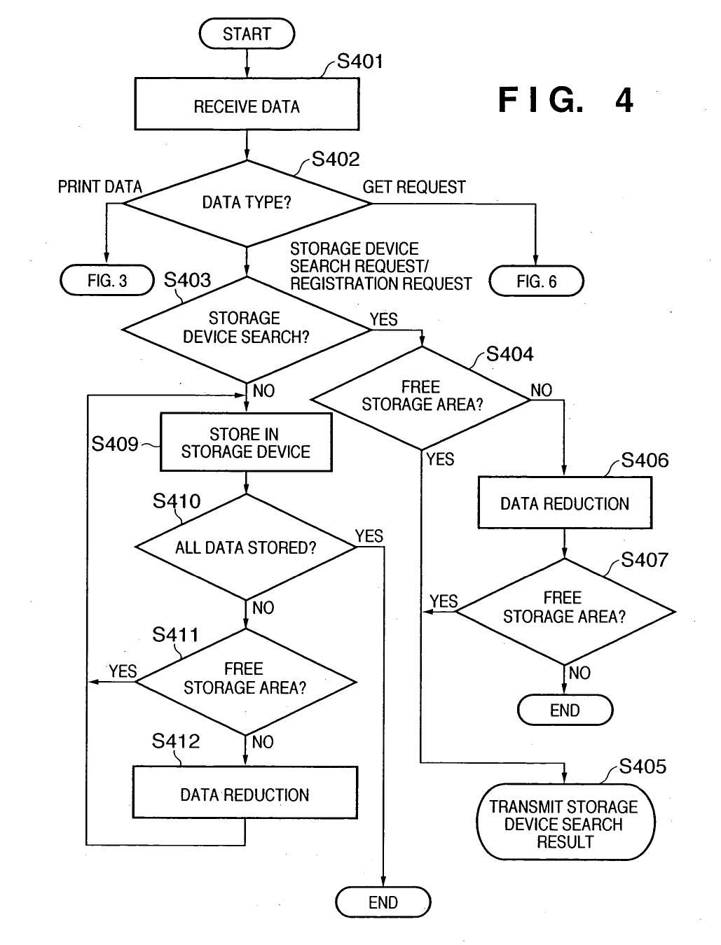

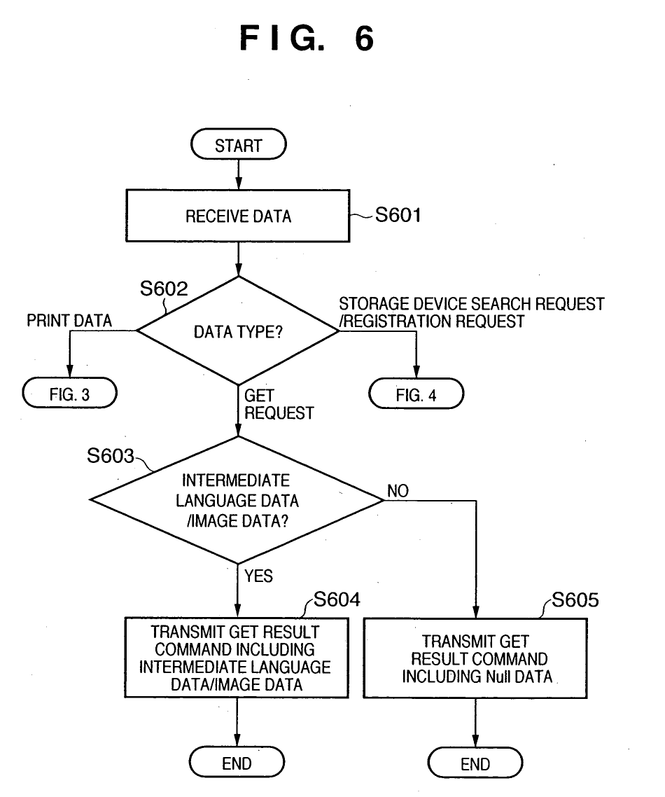

The communication interface 126 receives data (step S301). The data receiving unit 220 interprets the received data and notifies the printer controller 221 of the interpretation result (step S302). If the received data is a storage device search/registration request command, the flow advances to the process in FIG. 4. If the received data is a get request command, the flow advances to the process in FIG. 6. Note that details of FIGS. 4 and 6 will be explained later.

On the other hand, if the received data is print data, the printer controller 221 checks if the self device has a storage device (step S303). If the self device has a storage device (YES in step S303), the flow advances to step S304. On the other hand, if the self device does not have any storage device (NO in step S303), the flow advances to step S309.

Note that the storage device in step S303 means a storage device which has a storage area of a predetermined size (e.g., 500 Mbytes or more) which can store and manage the print data. Such storage device corresponds to a hard disk drive or optical disk drive (DVD-RAM or the like). In this embodiment, an HDD is used as this storage device.

For this reason, since the MFP 120 includes the HDD 124 as the storage device, it is determined in step S303 that the self device includes a storage device. On the other hand, in case of the printing apparatus 110, it is determined that the self device has no storage device.

If it is determined in step S303 that the self device includes a storage device, it is checked if the storage device has a free storage area for storing the print data (step S304). If the storage device has a free storage area (YES in step S304), the renderer 225 renders the intermediate language data 224 obtained from the PDL interpreter 223 to generate image data 226 (step S305).

The printer controller 221 registers the print data in the state of the intermediate language data 224 or image data 226 in the storage device (e.g., HDD 124) (step S306). In other words, processed data (intermediate language data or image data) generated in the process of applying the processing required to execute a printing process based on the print data to that print data is registered in the storage device (e.g., HDD 124).

The printer controller 221 appends, on the image data 226, identification information that includes location information in the storage device (e.g., HDD 124) that registers the intermediate language data 224 or image data 226, and a file name and the address of the self device (note that the address is full-path information that includes a URL (or URI), device name, directory, and file name, and indicates the storage destination of the digital data) (step S307). The printer engine 125 prints the image data 226 appended with the identification information (step S308).

Note that this identification information can be expressed by barcode information such as a two-dimensional barcode or the like, arbitrary character string information, or digital watermark information.

On the other hand, if it is determined in step S303 that no storage device is available or if it is determined in step S304 that no free storage area is available, a storage device search process for making another device on the network 130 provide a storage device used to store the print data is executed (step S309).

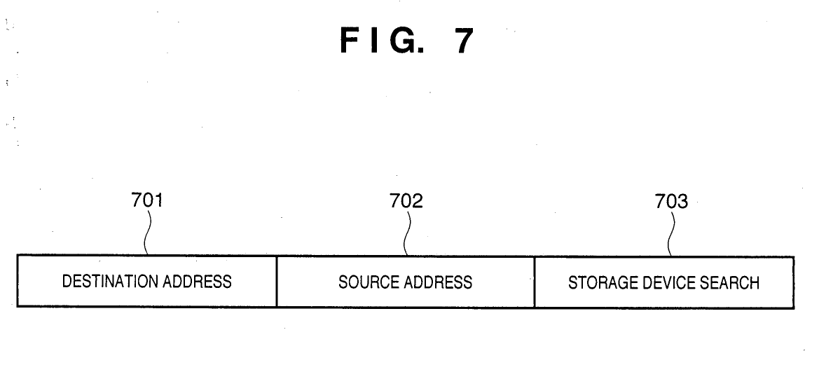

Note that the storage device search process is conducted by broadcasting a storage device search request command with the data (packet) configuration shown in FIG. 7 from the data transmitting unit 222 onto the network 130. A storage device to be retrieved by the storage device search process is, for example, a large-capacity storage device such as an HDD or the like which can store a certain volume of data, and is a sharing storage device whose read/write accesses of data in storage devices (resources) are made by a general-purpose file sharing system between the devices on the network. To this sharing storage device, an access right of data may be set for predetermined units (e.g. for respective devices/users).

Details of the storage device search request command will be described below using FIG. 7.

FIG. 7 shows an example of the data configuration of the storage device search request command according to the embodiment of the present invention.

Referring to FIG. 7, reference numeral 701 denotes a destination address, which describes an address that means broadcasting in this case. Reference numeral 702 denotes an address of the self device (source address). Reference numeral 703 denotes an area indicating a command. In this case, the area 703 describes a code having a meaning “storage device search”. The operation of the device which receives the storage device search request command shown in FIG. 7 will be described later using FIG. 4.

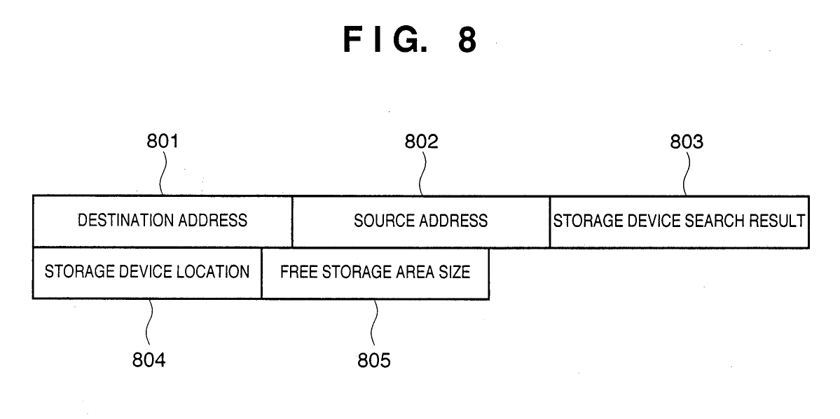

The device that has conducted the storage device search waits for a response to broadcasting until a time-out is generated (steps S310 and S311). If a reply is returned (YES in step S310), a storage device search result command with the data (packet) configuration shown in FIG. 8 is returned as the reply.

Details of the storage device search result command will be described below using FIG. 8.

FIG. 8 shows an example of the data configuration of the storage device search result command according to the embodiment of the present invention.

Referring to FIG. 8, reference numeral 801 denotes a destination address. That is, the address of the self device that conducted “storage device search”, i.e., the same address as the source address 702 in FIG. 7, is described. Reference numeral 802 denotes an address of a device that responds to the storage device search (source address). That is, the device which has a storage device having a free storage area for storing the print data and generates this storage device search result command is described.

Reference numeral 803 denotes an area indicating a command. In this case, the area 803 describes a code having a meaning “storage device search result”. Reference numeral 804 denotes a storage device location (address) having a free storage area of the device of the source address 802. Reference numeral 805 denotes a size of the free storage area.

For example, if an environment in which Windows(R) is installed as an operating system is assumed, and a given PC (personal computer) on the network 130 has a storage device having a free storage area, the source address 801 describes, e.g., “IP address of PC”, and the storage device location 804 describes, e.g., path information like “C:¥”.

The description will revert to FIG. 3.

If the storage device search result command is returned as the reply, the renderer 225 renders the intermediate language data 224 obtained from the PDL interpreter 223 to generate image data 226 (step S312).

The printer controller 221 registers the print data in the state of the intermediate language data 224 or image data 226 in the storage device of the other device on the network 130, which is found the previous storage device search process (step S313).

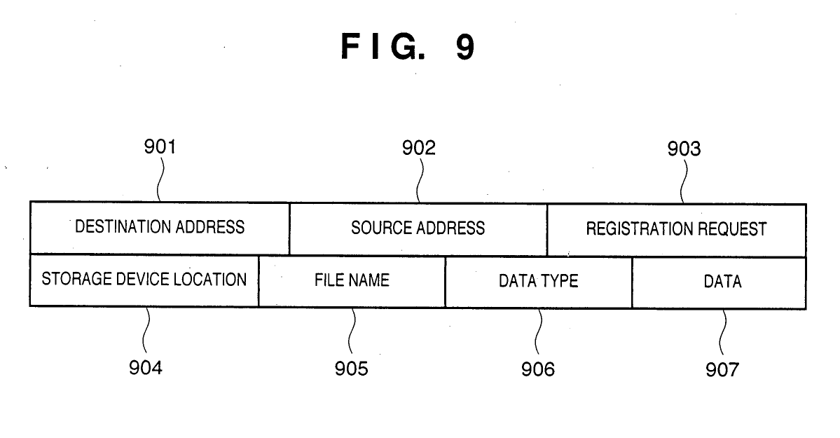

Upon registering the print data on the storage device of the other device on the network 130, a registration request command with the data (packet) configuration shown in FIG. 9 is transmitted to that device.

Details of the registration request command will be described below using FIG. 9.

FIG. 9 shows an example of the data configuration of the registration request command according to the embodiment of the present invention.

Referring to FIG. 9, reference numeral 901 denotes a destination address. That is, the destination address 901 describes an address of the device which has the storage device having the free storage area. Note that the destination address 901 describes the same address as the source address 802 in FIG. 8. Reference numeral 902 denotes an address of the self device (source address). That is, the address 902 describes the same address as the destination address 801 in FIG. 8. Reference numeral 903 denotes an area indicating a command. In this case, a code having a meaning “registration request” is described. Reference numeral 904 denotes a storage device location in the device at the destination address 901, which is the same as the storage device location 804 in FIG. 8.

Reference numeral 905 denotes a file name of the data to be registered. Reference numeral 906 denotes a data type indicating whether the data to be registered is intermediate language data or image data. Reference numeral 907 denotes actual data to be registered.

Note that the same effect can be obtained even when the storage device location 904, file name 905, and data 907 may have either fixed length or variable lengths by separately assuring an area that indicates the data length.

The description will revert to FIG. 3.

The printer controller 221 appends, to the image data 226, identification information including location information (904 and 905) in the storage device in which either the intermediate language data 224 or image data 226 is registered (step S314). Then, the printer engine 125 prints the image data 226 appended with the identification information (step S315).

On the other hand, if it is determined in step S311 that no reply is returned with a predetermined period of time (i.e., if a time-out is generated), the printer controller 221 determines that no storage device having a free storage area is available on the network 130. Then, the renderer 225 renders the intermediate language data 224 obtained from the PDL interpreter 223 to generate image data 226 (step S316). The printer engine 125 prints that image data (step S317).

The storage device search/registration process executed when the device (printing apparatus 110 or MFP 120) on the network 130 receives a storage device search/registration request command as the received data will be described below using FIG. 4.

FIG. 4 is a flowchart showing a storage device search/registration process according to the embodiment of the present invention.

Note that FIG. 4 will exemplify a case wherein the MFP 120 receives the storage device search/registration request command and executes a storage device search/registration process.

The communication interface 126 receives data (step S401). The data receiving unit 220 interprets the received data and notifies the printer controller 221 of the interpretation result (step S402). If the received data is print data (print request command), the flow advances to the process in FIG. 3. If the received data is a get request command, the flow advances to the process in FIG. 6. Note that details of FIG. 6 will be explained later.

On the other hand, if the received data is a storage device search request command (FIG. 7)/registration request command (FIG. 9), it is checked if the received data is a storage device search request command (step S403). If the received data is a storage device search request command (YES in step S403), the printer controller 221 checks if the storage device (e.g., HDD 124) has a free storage area for storing print data (step S404). If a free storage area is available (YES in step S404), a storage device search result command (FIG. 8) is generated and replied (step S405).

On the other hand, if no free storage area is available (NO in step S404), data reduction in the storage device is done to try to generate a free storage area (step S406). After that, the presence/absence of a free storage area for storing print data is checked again (step S407). If a free storage area is available (YES in step S407), the flow advances to step S405. On the other hand, if no free storage area is available (NO in step S407), the processing ends without any reply.

If the printing apparatus 110 having no storage device receives the storage device search request command (FIG. 7) in step S403, it ignores that command and does nothing.

On the other hand, if it is determined in step S403 that the received data is a registration request command (FIG. 9) (NO in step S403), a file with a name designated by the file name 905 is created at the storage device location 904 in the storage device designated by that registration request command, and the data type 906 and data 907 are stored in that file (step S409).

It is checked if all data to be stored can be stored (step S410). If all data can be stored (YES in step S410), the processing ends. On the other hand, if all data cannot be stored (NO in step S410), i.e., if the free storage area is used up before all data are stored (step S411), data reduction in the storage device is made to try to generate a free storage area for storing data to be stored (step S412).

As the data reduction method for generating a free storage area in step S406 or S412, for example, the following methods may be used.

When data to be stored (intermediate language data/image data) are stored up to a predetermined size, and when the predetermined size has exceeded, new data to be registered is stored while erasing data in the order of older ones in the storage device in a FIFO (First In First Out) manner.

When data to be stored (intermediate language data/image data) are stored up to a predetermined size, and when the predetermined size has exceeded, new data to be registered is stored while erasing data in the storage device in the order of older accesses.

Stored data (intermediate language data/image data) are erased in the order of data of which a predetermined storage time (e.g., one month) has elapsed, and new data to be registered is stored.

When data to be stored (image data) are stored up to a predetermined size, and when the predetermined size has exceeded, new data to be registered is registered while executing compression of data at a higher compression rate in the order of older registration date and re-saving the compressed data.

When data to be stored (intermediate language data) are stored up to a predetermined size, and when the predetermined size has exceeded, new data to be registered is stored, while data whose size becomes smaller when it is re-saved as image data is searched for, and that data is rendered and re-saved as image data.

If a free storage area for storing new data to be registered cannot be assured by executing the aforementioned data reduction method in step S406, the processing ends.

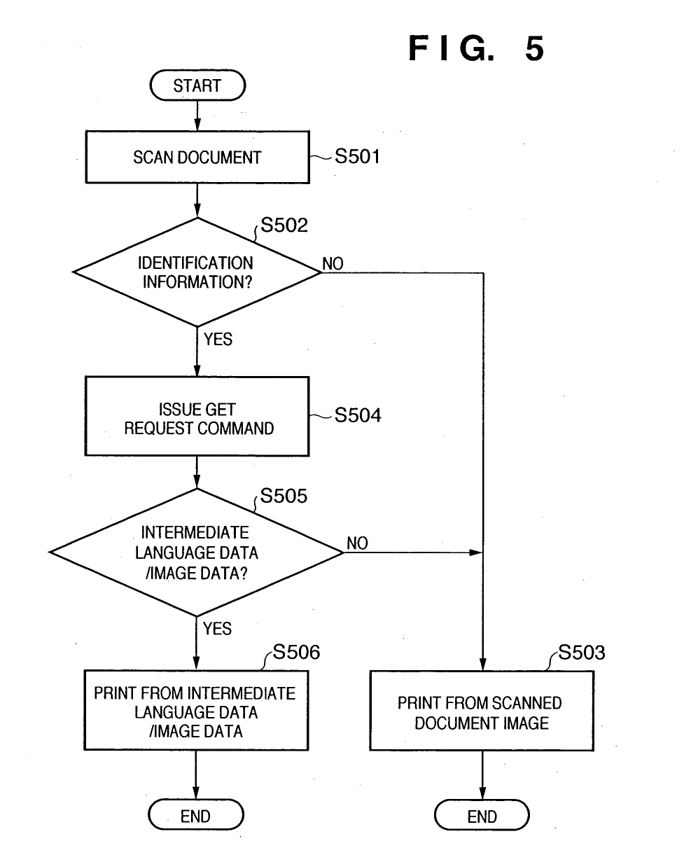

A copying process executed when a print appended with identification information is to be copied will be described below using FIG. 5.

FIG. 5 is a flowchart showing a copying process according to the embodiment of the present invention.

Note that FIG. 5 will exemplify a case wherein the MFP 120 executes a copying process.

Upon reception of a copying operation instruction, a document set on the scanner 127 is scanned (step S501). The printer controller 221 checks if the scanned document image includes identification information (step S502). If no identification information is included (NO in step S502), that scanned document image is printed by the printer engine 125 (step S503).

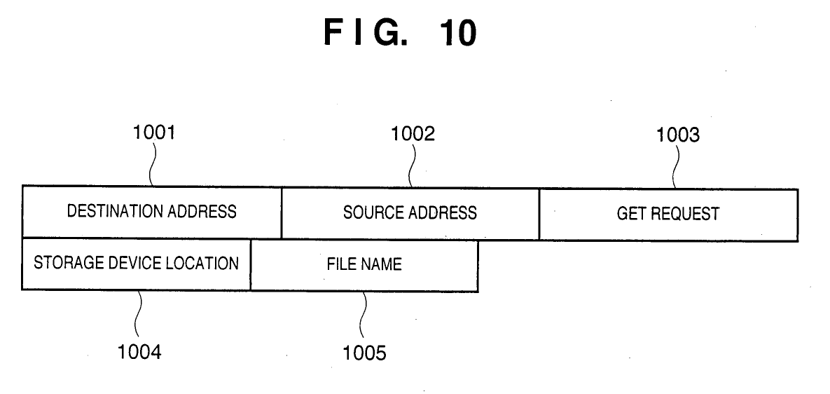

On the other hand, if identification information is included (YES in step S502), a get request command with the data (packet) configuration shown in FIG. 10, which requests the device having the storage device specified by the identification information to acquire print data corresponding to that scanned document image, is issued.

Details of the get request command will be described below using FIG. 10.

FIG. 10 shows an example of the data configuration of a get request command according to the embodiment of the present invention.

Referring to FIG. 10, reference numeral 1001 denotes a destination address, which stores an address of the device having the storage device specified by the identification information. Reference numeral 1002 denotes a source address which stores the address of the device that executes the copying process. Reference numeral 1003 denotes an area indicating a command. In this case, the area 1003 describes a code. having a meaning “get request”. Reference numeral 1005 denotes a storage device location of the source address 1001. Reference numeral 1006 denotes a file name of data which is to be acquired by the get request. In this embodiment, the storage device location 1005 and file name 1006 respectively correspond to the storage device location 904 and file name 905 in FIG. 9.

The description will revert to FIG. 5.

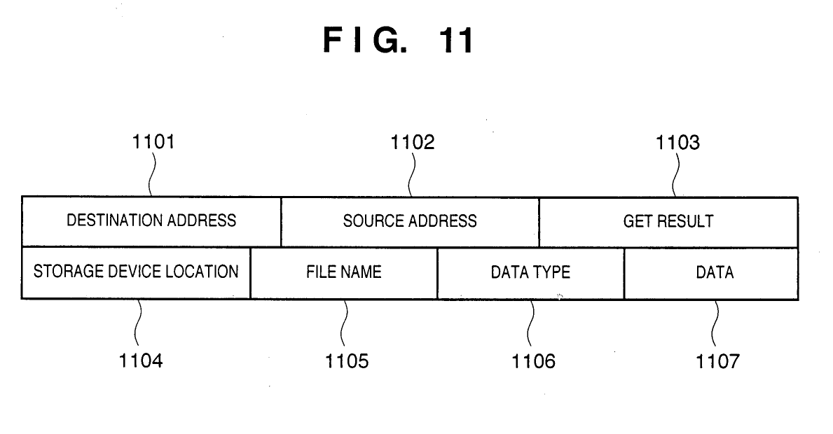

After the get request command, a get result command with the data (packet) configuration shown in FIG. 11 is returned as its reply.

Details of the get result command will be described below using FIG. 11.

FIG. 11 shows an example of the data configuration of a get result command according to the embodiment of the present invention.

Referring to FIG. 11, reference numeral 1101 denotes a destination address, which describes the same address as the source address 1002 in FIG. 10. Reference numeral 1102 denotes a source address, which describes the same address as the destination address 1001 in FIG. 10.

Reference numeral 1103 denotes an area indicating a command. In this case, the area 1103 describes a code with a meaning “get result”. Reference numeral 1104 denotes a storage device location, which describes the same value as the storage device location 1004 in FIG. 10.

Reference numeral 1105 denotes a file name to be gotten, which describes the same value as the file name 1005 in FIG. 10. Reference numeral 1106 denotes a data type indicating whether data to be gotten is intermediate language data or image data. Reference numeral 1107 denotes actual data to be gotten.

If intermediate language data or image data as the data to be gotten has already been deleted, Null data is stored in the data type 1106 and data 1107.

The description will revert to FIG. 5.

If the get result command is received as the reply, the data type 1106 and data 1107 in that command are interpreted, and it is checked if the data type is intermediate language data/image data (step S505). If the data type is not intermediate language data/image data (NO in step S505), that is, if the data type 1106 and data 1107 are Null data, the scanned document image is printed by the printer engine 125 (step S503).

On the other hand, if the data type is intermediate language data/image data (YES in step S505), the printer controller 221 processes the data 1107 on the basis of information of the data type 1106 and data 1107.

If the data 1107 is intermediate language data 224, the renderer 225 renders that intermediate language data 224 to generate image data 226. Then, identification information is appended to that image data 226. On the other hand, if the data 1107 is image data 226, identification information is appended to that image data 226. After that, the image data appended with the identification information is printed by the printer engine 125 (step S506).

A get request response process executed when the device on the network 130 (printing apparatus 110 or MFP 120) receives a get request command as the received data will be described below using FIG. 6.

FIG. 6 is a flowchart showing a get request response process according to the embodiment of the present invention.

Note that FIG. 6 will exemplify a case wherein the MFP 120 executes the get request response process.

The communication interface 126 receives data (step S601). The data receiving unit 220 interprets the received data and notifies the printer controller 221 of the interpretation result (step S602). If the received data is print data, the flow advances to the process in FIG. 3. If the received data is a storage device search/registration request command, the flow advances to the process in FIG. 4.

On the other hand, if the received data is a get request command (FIG. 10), the printer controller 221 checks if intermediate language data/image data is present as a file designated by the file name 1005 at the storage device location 1004 in the storage device designated by that get request command (step S603).

If intermediate language data/image data is present (YES in step S603), a get result command including that intermediate language data/image data is transmitted to the source device of the get request command (step S604). On the other hand, if no intermediate language data/image data is present (NO in step S603), Null data is stored in the data type 1106 and data 1107, and a get result command including these data is transmitted to the source device of the get request command (step S605).

Note that the case has been exemplified wherein the aforementioned flowcharts are executed by the MFP 120. However, the same processes can be implemented for the printing apparatus 110 except for the copying process.

As described above, according to this embodiment, upon reception of print data, processed data (intermediate language data or image data) which is generated in the process of applying the processing (that by the PDL interpreter and renderer) required to execute a printing process based on the print data to that print data is registered in the storage device in the self device or that in another device on the network.

On the other hand, when the printing process based on that print data is to be executed, the print data is printed while appending identification information indicating the storage destination of the registered processed data to image data corresponding to the print data.

When the copying process using a print appended with the identification information is to be executed, a copy of that print is generated using the processed data specified by that identification information.

In this manner, a copying process free from any image quality drop can be realized, and the processing time required to print (copy) can be reduced.

The present invention is not limited to the above embodiments and various changes and modifications can be made within the spirit and scope of the present invention. Therefore, to appraise the public of the scope of the present invention, the following claims are made.

### Claim of Priority

This application claims priority from Japanese Patent Application No. 2004-117057 filed on Apr. 12, 2004, the entire contents of which are hereby incorporated by reference herein.

1. A printing apparatus which is connected to a plurality of devices via a network, and executes a printing process on the basis of print data received from the plurality of devices, comprising:
a receiving unit adapted to receive the print data;
a processing unit adapted to apply to the print data processing required to execute the printing process based on the print data;
a storing unit adapted to store processed data generated during a process of the processing of said processing unit in one of storage devices incorporated in the devices including said printing apparatus on the network;
an appending unit adapted to append identification information indicating a storage location of the processed data by said storing unit to image data corresponding to the print data; and
a printing unit adapted to print the image data to which the identification information is appended by said appending unit.

2. The apparatus according to claim 1, wherein the print data is print data in a PDL format, and
the processed data is intermediate language data obtained by interpreting the print data in the PDL format or image data corresponding to the print data in the PDL format.

3. The apparatus according to claim 1, wherein when a storage device included in said printing apparatus has no free storage area, said storing unit stores the processed data in one of the storage devices incorporated in the devices other than said printing apparatus on the network.

4. The apparatus according to claim 1, further comprising:
a storage device adapted to store data;
a registration unit adapted to register, when the processed data including a registration request is received from the device on the network, the processed data in said storage device; and
a registration control unit adapted to reduce, when the free storage area required to store the processed data to be registered is used up during registration of the processed data to be registered by said registration unit, data that have already been stored in said storage device, and register the processed data to be registered in said storage device.

5. The apparatus according to claim 4, wherein said registration control unit registers the processed data to be registered in said storage device while erasing data stored in said storage device in an order of older ones.

6. The apparatus according to claim 4, wherein said registration control unit registers the processed data to be registered in said storage device while erasing data stored in said storage device in an order of older accesses.

7. The apparatus according to claim 4, wherein said registration control unit registers the processed data to be registered in said storage device while erasing data stored in said storage device in an order of data for which a predetermined period of time have elapsed.

8. The apparatus according to claim 4, wherein said registration control unit registers the processed data to be registered in said storage device while applying compression at a higher compression rate to data stored in said storage device and re-saving the compressed data in an order of data with older registration dates.

9. The apparatus according to claim 4, wherein said registration control unit registers the processed data to be registered in said storage device while searching the data stored as intermediate language data in said storage device for data which may have a smaller size if it is saved as image data, rendering the found data, and re-saving the rendered data as image data.

10. The apparatus according to claim 1, further comprising:
a scanning unit adapted to optically scan a document; and
an acquisition unit adapted to acquire, when the document scanned by said scanning unit includes the identification information, the processed data corresponding to the identification information from the storage location specified by the identification information, and wherein
said printing unit executes the printing process based on the processed data acquired by said acquisition unit.

11. A method of controlling a printing apparatus which is connected to a plurality of devices via a network, and executes a printing process on the basis of print data received from the plurality of devices, comprising:
a receiving step of receiving the print data;
a processing step of applying processing required to execute the printing process based on the print data to the print data;
a storing step of storing processed data generated during a process of the processing in the processing step in one of storage devices incorporated in the devices including the printing apparatus on the network;
an appending step of appending identification information indicating a storage location of the processed data in the storing step to image data corresponding to the print data; and
a printing step of printing the image data to which the identification information is appended in the appending step.

12. A program for implementing control of a printing apparatus which is connected to a plurality of devices via a network, and executes a printing process on the basis of print data received from the plurality of devices, comprising:
a program code of a receiving step of receiving the print data;
a program code of a processing step of applying processing required to execute the printing process based on the print data to the print data;
a program code of a storing step of storing processed data generated during a process of the processing in the processing step in one of storage devices incorporated in the devices including the printing apparatus on the network;
a program code of an appending step of appending identification information indicating a storage location of the processed data in the storing step to image data corresponding to the print data; and
a program code of a printing step of printing the image data to which the identification information is appended in the appending step.
